(19) United States
(12) Patent Application Publication
(10) Pub. No.: US 2016/0069478 A1
(43) Pub. Date: Mar. 10, 2016

(54) IMPROVED TENSIONER PAD ASSEMBLY

(71) Applicant: MACKINNON MARINE LIMITED, Johnshaven, Aberdeenshire (GB)

(72) Inventor: Alex Vincent MACKINNON, Johnshaven, Aberdeenshire (GB)

(21) Appl. No.: 14/784,572

(22) PCT Filed: Apr. 23, 2014
(86) PCT No.: PCT/GB2014/051266

§ 371 Date: Oct. 14, 2015

(30) Foreign Application Priority Data
Apr. 23, 2013 (GB) 1307336.6

(51) Int. Cl. F16L 1/23; F16L 1/20; F16L 1/235

(52) U.S. Cl. CPC F16L 1/23; F16L 1/235; F16L 1/207; F16L 1/205

(57) ABSTRACT

The invention provides improvements to the tensioner pads (513) which engage with the surface of elongate articles in tensioners such as used on offshore pipelaying and construction vessels to deploy products such as pipelines, cables and umbilicals, wherein tensioner pad assemblies (511) according to the invention may include; two or more tensioner pads and present a first tensioner pad to the product when in a first configuration and present a second tensioner pad to the product when in a second configuration; a split tensioner pad with a means (525) for controlling the separation between the portions (513i,513ii) of the pad; and combinations thereof. The invention allows a tensioner to accommodate products of different shapes, sizes and materials without having to swap tensioner pad assemblies.

The present invention relates to the field of tensioners such as used on offshore pipelaying and construction vessels to deploy elongate articles such as pipelines, cables and umbilicals. More specifically, the present invention concerns improvements to the tensioner pads which engage with the surface of elongate articles in track type tensioners and elements thereof. In a particular embodiment of the invention there is provided a tensioner pad assembly having a split tensioner pad with a means for controlling the separation between the portions of the pad to accommodate elongate articles of different diameters.

### BACKGROUND TO THE INVENTION

FIG. 1 illustrates in schematic form a typical pipelaying vessel 101 for laying product 103, such as submarine oil or gas pipes, flexible pipelines and risers, electrical or umbilical cables, from an integrated deck-mounted reel 105. The optimum lay speed and other process parameters are dependent on many factors such as vessel speed, sea state, product characteristics and water depth. Lay speed is regulated by one or more tensioners 107 whose speed is coordinated with the speed of rotation of the reel 105.

Further detail of a typical tensioner arrangement 207 is illustrated in FIG. 2. The product 203 is gripped between opposing tracks 209, each of which comprises several tensioner pads 211 mounted on a chain (not shown). A dedicated drive system 213 operates the tensioner 207 in a forward or reverse mode to drive or brake deployment of the product—for example at the initial deployment stage the tensioner 207 is driven in a forward mode to drive the product 203 through the system and into the water and once the weight of the product exceeds the forces necessary to drive the product a braking force is applied to maintain control of the running of the product.

Typically, the pads 211 comprise natural or synthetic rubber, polyurethane or steel, whereas the product 203 (or at least the outer surface of the product 203) comprises bare steel coated with corrosion resistant and insulation coatings such as Fusion Bonded Epoxy, Polyethylene, Polypropylene or Glass Syntactic Polyurethane. The surfaces of the pads 211 and/or of the product 203 may be smooth or textured for grip.

A controlled squeeze pressure (on the product) is applied via the tensioner tracks 209 by biasing apparatus 215. The resulting coefficient of friction between the pads 211 and the product 203 is dependent on the material of the pads 211 and of the product 203, the surface of the pads 211 and of the product 203 and any texture thereon, and particularly the pressure between the surfaces which is dependent on the area of contact there between.

FIG. 3 illustrates in schematic form three different types of pad 311; (a) with a small rubber pad portion 313a with a curved surface corresponding to a small product 303a represented in two-track mode typical of umbilical installation, (b) a large rubber pad portion 313b with a curved surface corresponding to a large product 303b represented in 4 track mode typical of rigid pipeline installation, and (c) a steel pad portion 313c with a v-shaped surface represented in 4 track mode typical of flexible pipeline installation. To optimise the coefficient of friction for specific lay projects, it will be understood that different pad materials and shapes must be used for different products. It is therefore necessary to change the pads on the tensioners when there is a significant change in product diameter, coating material or if installation parameters so dictate. Several such tensioner pad changes may occur during a pipelay campaign or indeed during a single pipelay trip.

FIG. 4 illustrates in more detail a tensioner pad 413, which is either directly connected to the tensioner chain 417 or mounted to a spring base which is attached to the tensioner chain 417 of the tensioner track (not shown but as previously illustrated). The spring base located between the tensioner pad 413 and the tensioner chain 417 comprise a number of spring elements 419 which provide resilience and bias the pad 413 towards the product 403. Whether by selection of an appropriate material for the pad 413 and/or inclusion of such biasing means as said springs 419 the pad assembly 411 overall should be compliant to allow the pads to compress and/or retract so that changes in the diameter of the product can be accommodated. The diameter changes may arise from product outer diameter variations due to manufacturing tolerances, the presence of field joint coatings, diameter steps or transitions from one diameter to another.

Nonetheless, flexibility is still significantly limited and tensioner pads must be changed for different product diameters or diameter variations for a single product, different load requirements and different product materials and surface finishes. Replacing pads with pads of another design or different performance can take in the region of 16 to 24 hours for each tensioner, and can only take place when the lay process is stopped. As the daily cost of running a pipelaying vessel is typically in the region of $500,000, taking the vessel out of operation for pad changeover has significant cost implications. Furthermore, packing and storage space on deck and handling are required for the tensioner pads that are not in use, and many different sets of pads are required to accommodate a full range of product sizes and materials.

These problems are common to all operators involved in the laying or handling of more than one product specification with the same tensioner.

Accordingly, it is an object of at least one aspect of the present invention to provide a tensioner pad assembly that reduces the requirement for an operator to carry multiple tensioner pads for different applications.

Further aims and objects of the invention will become apparent from reading the following description.

### SUMMARY OF THE INVENTION

According to a first aspect of the invention there is provided a tensioner pad assembly for a track type tensioner, the tensioner pad assembly comprising a plurality of tensioner pads and configured to present a first of the tensioner pads to a product when in a first configuration and present a second of the tensioner pads to the product when in a second configuration.

The above invention provides a means for accommodating different products which require different pads, e.g. different shapes, different sizes or different materials, without having to remove one set of tensioner pad assemblies to replace them with another set of tensioner pad assemblies. Again, product will be understood to relate to any suitable lay product.

Most preferably, the second of the tensioner pads is held in a storage position when the tensioner pad assembly is in the first configuration, and/or vice versa. Optionally, the tensioner pad assembly comprises one or more supports configured to locate and/or support the first or second tensioner pad when in the storage position. Optionally, the one or more supports comprise a flexible, resilient and/or compressible material. Alternatively, the tensioner pad assembly may be arranged such that the tensioner pads themselves provide the tensioner pad assembly with flexibility, resilience and/or compressibility.

Preferably two or more tensioner pads are mounted on opposing faces of one or more corresponding pad carriers. Optionally, the pad carriers are plates.

Preferably, the tensioner pad assembly comprises a mounting frame, the mounting frame providing a means for translating the tensioner pad assembly between the first configuration and the second configuration. To this end, the mounting frame may comprise one or more arms or linkages, to which the tensioner pads or corresponding pad carriers are connected. Preferably, the one or more tensioner pads or corresponding pad carriers are hingedly mounted on the mounting frame via one or more arms or linkages.

Most preferably, the mounting frame further provides a means for attaching the tensioner pad assembly to a tensioner. Optionally, the mounting frame is connectable directly to a chain or track of a tensioner.

In a preferred embodiment of the first aspect of the invention, the tensioner pad assembly comprises four tensioner pads, and is configured to present a first of the tensioner pads to the product when in a first configuration, a second of the tensioner pads to the product when in a second configuration, a third of the tensioner pads to the product when in a third configuration, and the fourth of the tensioner pads to the product when in a fourth configuration.

Preferably, the first and second tensioner pads are mounted on a first pad carrier, which may be a plate, and the third and fourth tensioner pads are mounted on a second pad carrier, which may also be a plate.

Optionally, the tensioner pad assembly further comprises one or more supports configured to locate and/or support the remaining tensioner pads when one of the tensioner pads is presented to the product, and optionally provide the tensioner pad assembly with flexibility, resilience and/or compressibility. Alternatively, or additionally, the tensioner pad assembly is arranged such that the remaining tensioner pads provide the tensioner pad assembly with flexibility, resilience and/or compressibility.

According to a second aspect of the invention there is provided a tensioner pad assembly for a track type tensioner, the tensioner pad assembly comprising a plurality of tensioner pads and configured to present a first of the tensioner pads to a product when in a first configuration and present a second of the tensioner pads to the product when in a second configuration, and one or more of the tensioner pads comprising a first pad portion, a second pad portion, and a separating means arranged to control a separation between the first pad portion and the second pad portion.

Embodiments of the second aspect of the invention may comprise features corresponding to the preferred or optional features of the first aspect of the invention or vice versa.

According to a third aspect of the invention, there is provided a tensioner pad assembly for a track type tensioner, the tensioner pad assembly comprising a tensioner pad comprising a first pad portion, a second pad portion, and a separating means arranged to control a separation between the first pad portion and the second pad portion.

The above invention provides a means for accommodating different product diameters without requiring multiple separate tensioner pad assemblies. In conventional pipe lay systems, when switching from a small pipe diameter to a large pipe diameter, it is usually necessary to replace all of the tensioner pads in the pipe tensioner. However, the invention allows the same tensioner pads to be used by increasing (or decreasing) the separation between discrete portions of a single tensioner pad. A track type tensioner may be a pipe tensioner used in the handling or laying of pipes or for other elongate articles such as umbilicals and cables.

Optionally, the separating means permits continuous adjustment of the separation between the first and second pad portions.

Optionally, the separating means comprises one or more threaded rods. Preferably, the separating means comprises at least one threaded rod extending between the first pad portion and second pad portion. Alternatively, the separating means comprises one or more hydraulic cylinders. Further alternatively, the separating means comprises one or more linear positioners, such as micrometers.

Alternatively, the separating means permits discrete adjustment of the separation between the first and second pad portions.

Optionally, the separating means comprises a number of apertures in positions corresponding to different separations between the first pad portion and the second pad portion, the apertures adapted to receive at least one retaining member which holds the first pad portion and the second pad portion at the corresponding separation. The retaining member may, for example, be a rod or a threaded bolt.

Still further alternatively, the separation means comprises a number of slots in the first and second pad portions which define a corresponding number of separations, and at least one retaining member adapted to be received in one or more of the slots to hold the first and second pad portions at the corresponding separation. Optionally, the retaining member comprises a rod. Preferably, the rod is pivotally mounted in the tensioner pad assembly. Preferably, the rod is pivotally mounted at a first end and is adapted to receive a retaining member at a second end.

Alternatively, the separating means comprises one or more hydraulic cylinders. Further alternatively, the separating means comprises one or more linear positioners, such as micrometers.

Preferably, the first pad portion, the second pad portion and/or a plate supporting the first and second pad portions comprise corresponding channels or grooves to align and/or guide the first and second pad portions when moved by the separating means.

Optionally, the pad portions are provided with inclination adjustment means to control the inclination of a contact surface of the pad portions. Preferably, the inclination adjustment means comprises one or more rotatable discs having at least a one sloping face contacting a surface of the pad portion. The sloping face is preferably an upper face contacting a lower face of the pad portion, or alternatively is a lower face contacting a plate or pad carrier. Preferably, a plurality of rotatable discs are interconnected so as to transfer rotation from one disc to the next. The rotatable discs may be rotated using a removable key, via a worm drive, or other equivalent means.

In a preferred embodiment of the third aspect of the invention, the inclination adjustment means is configured to adjust between a pad angle (i.e. the angle between contacting faces of the pad portions) of 140 degrees and a pad angle of 160 degrees.

Embodiments of the third aspect of the invention may comprise features corresponding to the preferred or optional features of the first or second aspects of the invention or vice versa.

According to a fourth aspect of the invention there is provided a tensioner comprising a plurality of tracks, each of the tracks comprising a plurality of tensioner pad assemblies according to the first, second and/or third aspects.

Embodiments of the fourth aspect of the invention may comprise features corresponding to the preferred or optional features of the first, second or third aspects of the invention or vice versa.

According to a fifth aspect of the invention there is provided a method of reconfiguring the tensioner of the fourth aspect comprising adjusting the separation between the first pad portion and the second pad portion of the first or third aspect, or translating the tensioner pad assembly of the second or third aspect between one configuration and another configuration, in order to accommodate a particular product.

Embodiments of the fifth aspect of the invention may comprise features corresponding to the preferred or optional features of the first to fourth aspects of the invention or vice versa.

According to a sixth aspect of the invention there is provided a method of laying a product comprising driving or braking the tracks of a tensioner according to the fourth aspect to control the speed at which the product is deployed.

Embodiments of the sixth aspect of the invention may comprise features corresponding to the preferred or optional features of the first to fifth aspects of the invention or vice versa.

According to a seventh aspect of the invention, an existing track type tensioner can be retrofitted by replacing existing tensioner pads with tensioner pad assemblies according to any of the first to third aspects of the invention.

The existing tensioner pads may already have been removed; otherwise the existing tensioner pads may first be removed prior to fitting the inventive tensioner pad assemblies.

Embodiments of the seventh aspect of the invention may comprise features corresponding to the preferred or optional features of the first to sixth aspects of the invention or vice versa.

According to another aspect of the invention, there is provided a tensioner pad assembly for a track type tensioner, a tensioner comprising one or more tensioner pad assemblies, a method of reconfiguring such a tensioner, or a method of laying a product using such a tensioner, substantially as herein described with reference to FIGS. 5 to 20.

### BRIEF DESCRIPTION OF THE DRAWINGS

Aspects and advantages of the present invention will become apparent upon reading the following detailed description and upon reference to the following drawings (like reference numerals referring to like features) in which:

FIG. 1 is a schematic representation of a typical pipelay vessel according to the prior art;

FIG. 2 is a schematic representation of a typical track type pipe tensioner according to the prior art;

FIG. 3 is a schematic representation of a number of typical tensioner pads according to the prior art;

FIG. 4 is a schematic representation of a typical tensioner pad mounting arrangement according to the prior art;

FIG. 5 is a schematic representation of a tensioner pad assembly according to an embodiment of the present invention;

FIG. 6 is a schematic representation illustrating two tensioner pad assemblies according to an embodiment of the invention gripping a pipe;

FIG. 7 is a schematic representation illustrating the pipe diameter adjustment achievable using the lateral separation adjustment mechanism of the tensioner pad assembly of FIG. 5;

FIG. 8 is a schematic representation illustrating the tensioner pad assembly of FIG. 5 replacing typical tensioner pads according to the prior art in a pipe tensioner track;

FIG. 9 is a schematic representation illustrating a tensioner pad assembly with an alternative arrangement for adjusting the lateral separation of the tensioner pad portions;

FIG. 10 is a schematic representation illustrating a tensioner pad assembly with a further alternative arrangement for adjusting the lateral separation of the tensioner pad portions;

FIG. 11 is a schematic representation of an alternative tensioner pad assembly according to another embodiment of the present invention;

FIG. 12 is a schematic representation of the tensioner pad assembly of FIG. 11 in a number of different configurations according to an embodiment of the present invention;

FIG. 13 is a schematic representation illustrating a tensioner pad assembly according to an alternative embodiment of the present invention;

FIG. 14 is a schematic representation illustrating a tensioner pad assembly according to another alternative embodiment of the present invention;

FIG. 15 is a schematic representation illustrating a tensioner pad assembly according to a further alternative embodiment of the present invention in a first configuration;

FIG. 16 is a schematic representation illustrating the tensioner pad assembly of FIG. 15 moving between the first configuration and a second configuration;

FIG. 17 is a schematic representation illustrating two tensioner pad assemblies of FIG. 15 and FIG. 16 gripping a pipe in the second configuration;

FIG. 18 is a schematic representation illustrating detail of the angular adjustment mechanism of the tensioner pad assembly of FIG. 15 and FIG. 16;

FIG. 19 is a schematic representation illustrating further detail of the angular adjustment mechanism detailed in FIG. 18; and

FIG. 20 is a schematic representation illustrating the angular adjustment effected by the angular adjustment mechanism shown in FIG. 18 and FIG. 19.

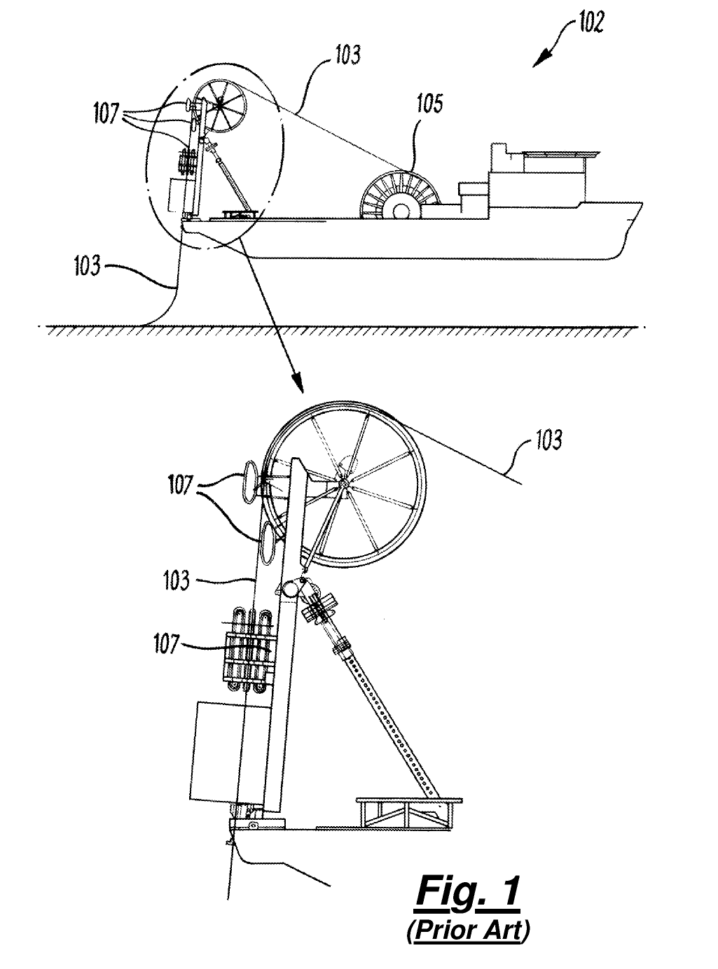

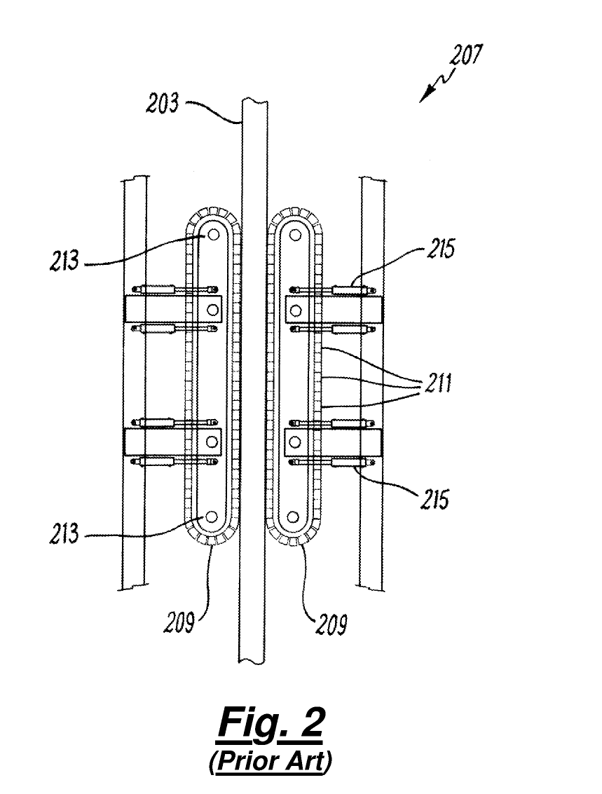

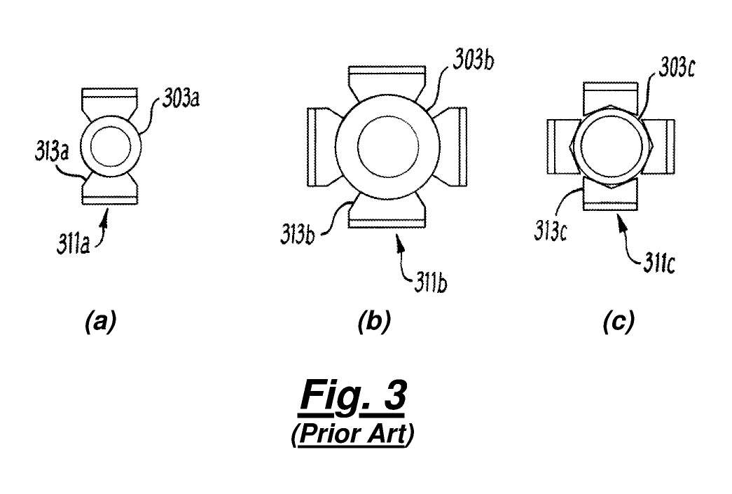

### DETAILED DESCRIPTION

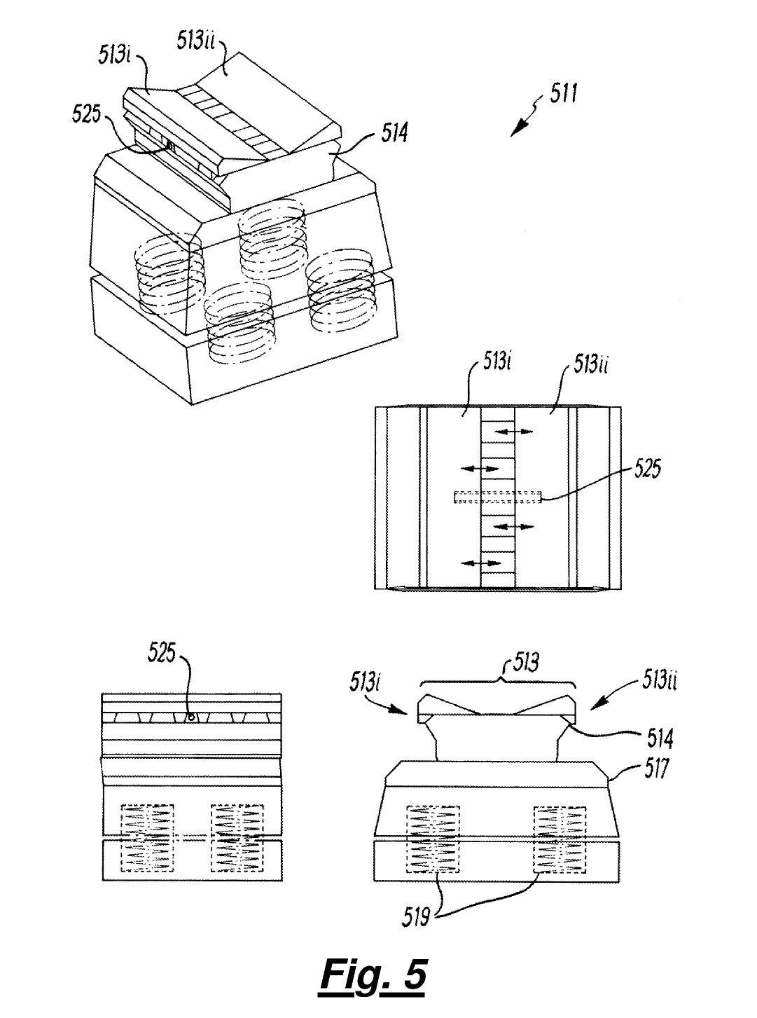

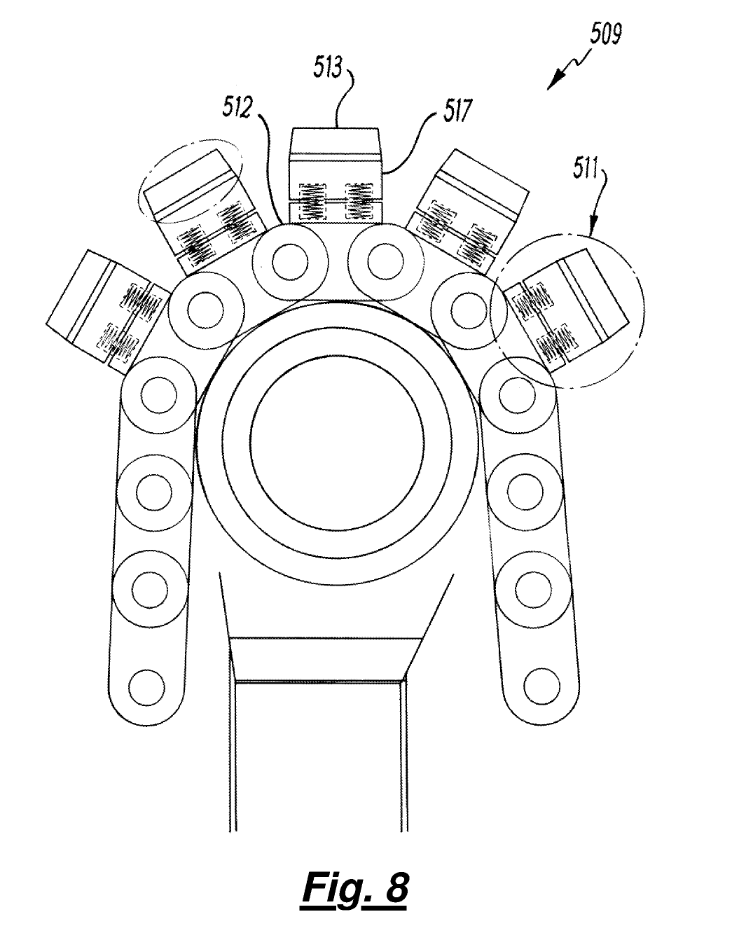

As discussed in the background to the invention above, operators are required to carry multiple tensioner pads to accommodate different products, different product sizes, different product materials and different product configurations. An embodiment of the present invention is illustrated in FIG. 5 which overcomes this problem with the prior art. An improved tensioner pad assembly 511 is shown which comprises a tensioner pad 513 which itself comprises two separate pad portions 513i,513ii which are moveable laterally across the face of pad plate 514 to adjust the separation there between. The separation is controlled by way of a threaded rod 525 which extends between the pad portions 513i,513ii and is accessible, and therefore may be adjusted, from the side. Rotation of the threaded rod 525 in a first direction causes the pad portions 513i,513ii to move apart and rotation of the threaded rod 525 in the opposite direction causes the pad portions 513i,513ii to move together. The pad portions 513i,513ii comprise elongate fingers which are received in corresponding grooves in the pad plate 514, aligning and guiding the pad portions 513i,513ii during adjustment. In FIG. 5, the pad plate 514 is mounted on a spring base 517 which comprises a number of springs 519 which provide resilience and bias the tensioner pad 513 towards the product. The spring base 517 is mountable on the chain 512 of a tensioner track 509 as illustrated in FIG. 8, which shows a number of tensioner pad assemblies 511 according to the present invention.

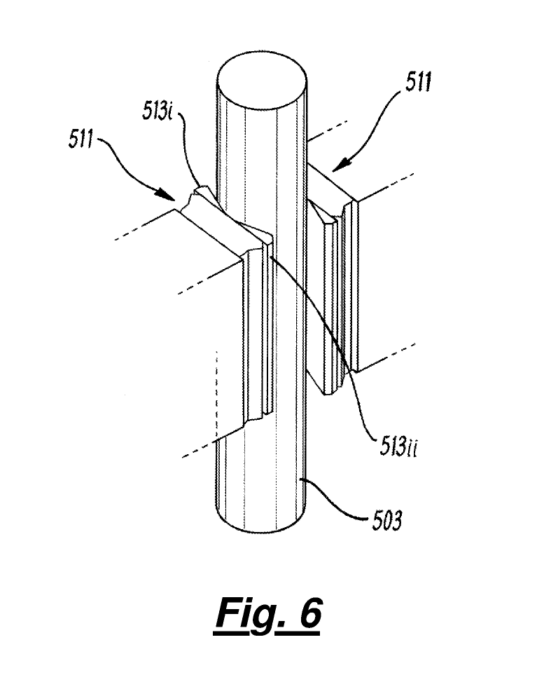

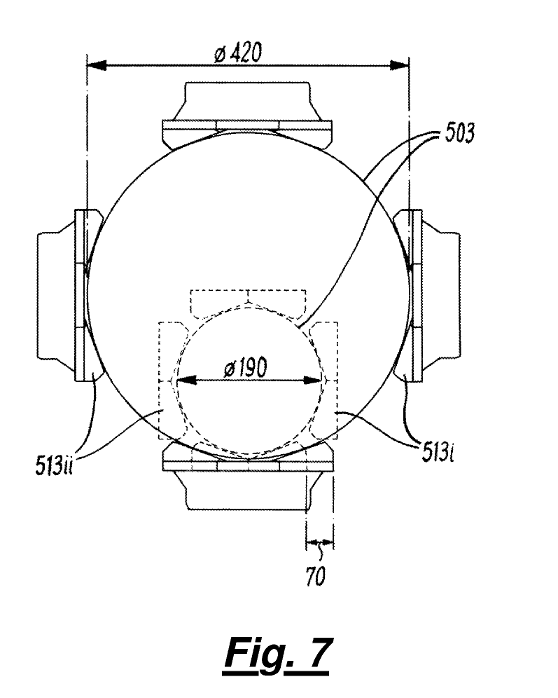

FIG. 6 shows two such improved tensioner pad assemblies 511 disposed on either side of a product 503. The pad portions 513i,513ii have been set at a separation suitable for the diameter of the product 503. However, as above, the separation of the pad portions 513i,513ii can be adjusted and this allows a single tensioner pad assembly 511 to accommodate different product diameters. FIG. 7 illustrates how accommodating a relatively minor pad portion travel allows for a significant range of product diameters to be handled. For example, within a travel of 70 mm, pipe diameters between 190 mm and 420 mm can be accommodated—without the need to change pads. The dashed lines indicate the position of the pad portions 513i,513ii for a 190 mm diameter product and the solid lines indicate the position of the pad portions 513i,513ii for the larger 420 mm product.

The applicant has realised that in the case of conventional tensioner pads (and particularly those of a v-shape), as product diameter increases the points of contact between the product and the pad move outward. Rather than having to change to larger pads as larger products are deployed, the applicant has proposed that the one-piece pad be replaced with a two-piece pad, said pieces being moveable apart from (or towards) one another to offer adequate contact with the product where it is needed (and where it would have been provided by an appropriately selected single continuous pad)—saving on material costs on what would otherwise be a substantially larger pad for a large diameter pipe, without the interference between neighbouring pads that would otherwise limit how small a diameter of product could be accommodated.

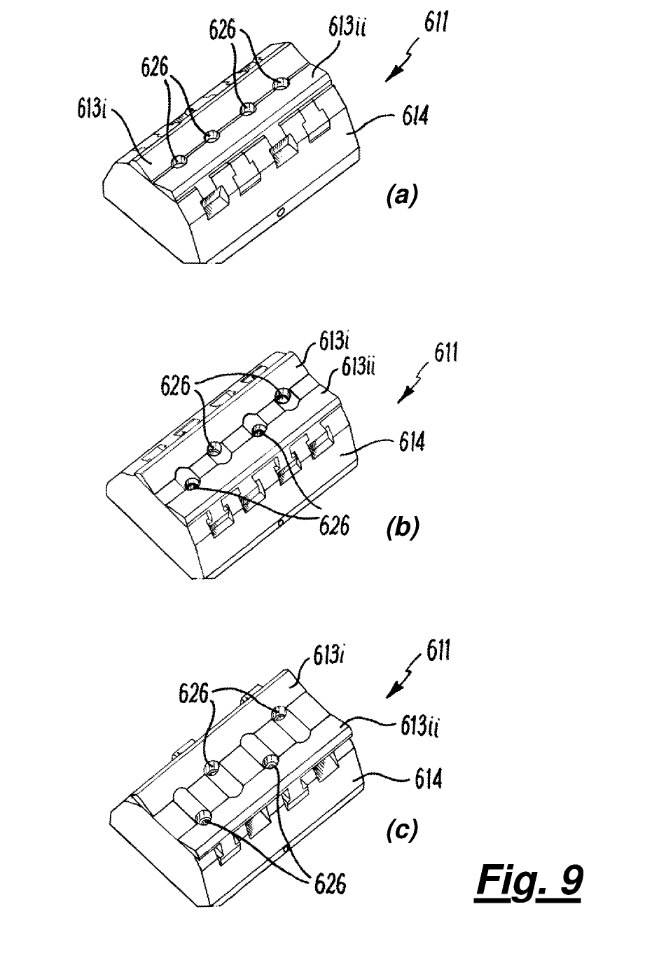

An alternative tensioner pad assembly 611 is illustrated in FIG. 9, and illustrates an alternative arrangement for adjusting or setting the separation between the pad portions 613i,613ii. As described above, the pad portions 613i,613ii comprise elongate fingers which are received in corresponding grooves in the pad plate 614, aligning and guiding the pad portions 613i,613ii during lateral adjustment. In this embodiment, each of these fingers comprises an aperture 626 which can receive a pin, rod, bolt or the like. A number of corresponding apertures (not visible) are provided in the pad plate 614 and allow the pad portions 613i,613ii to be fixed—by insertion of a pin, rod, bolt or the like through the apertures 626 in the fingers and into the apertures in the pad plate 614. FIGS. 6(a)-(c) show three separate pad configurations which correspond to three different sets of apertures in the pad plate 614.

Of course, there need not be apertures in the pad plate 614 and/or instead of receiving the pins, rods, bolts or the like in such apertures the separation could be set by use of a bolt or the like which is urged into frictional contact with the pad plate 614 (through the apertures in the fingers of the pad portions 613i,613ii) to hold the pad portions 613i,613ii in place.

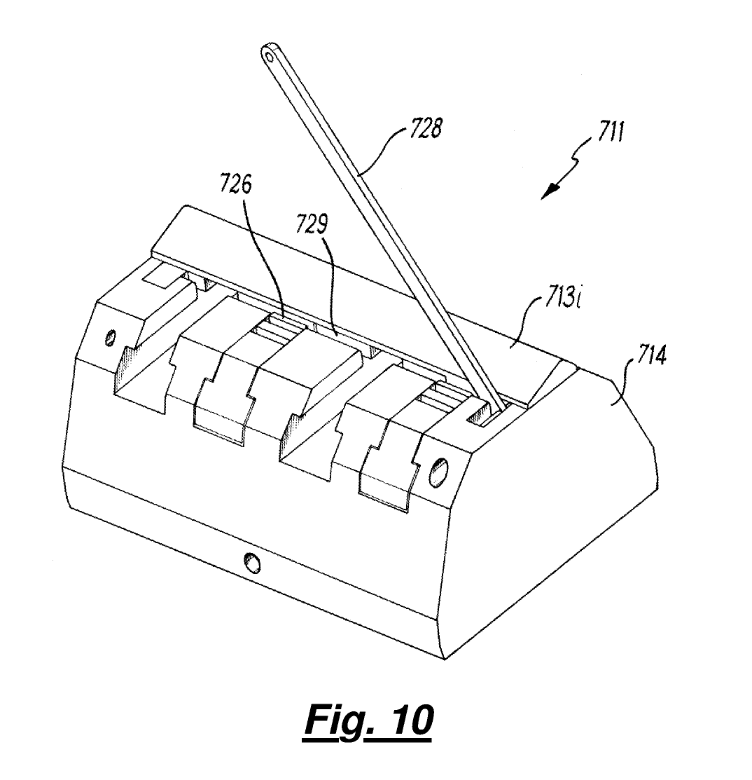

A further alternative tensioner pad assembly 711 is illustrated in FIG. 10, in which one of the pad portions has been made invisible for the purposes of illustration. Pad portion 713i can be seen, as in previously described embodiments, fingers which are received in and guided by corresponding grooves in the pad plate 714. In this particular embodiment, a rod 728 is hingedly attached at one end and is received in a corresponding slot 729 in the pad plate 714 which extends across the grooves and the fingers. Each of the fingers is provided with a number of slots 726 which can be aligned with the slot 729 in the pad plate 714 such that there is a continuous slot into which the rod 728 can be lowered. Selection of a different finger slot 726 will provide a different separation between the pad portions. In this embodiment, there are provided three slots 729 however any number of slots can be provided to provide the desired range of pad separations to accommodate a desired range of product diameters. When lowered, the rod 728 can be retained by a pin, rod, bolt or the like.

Although a number of specific arrangements for adjusting, controlling and setting the separation of the pad portions are described above (and below), it will be understood that any arrangement for adjusting, controlling and/or setting the separation of the pad portions will allow the benefits of the invention to be realised.

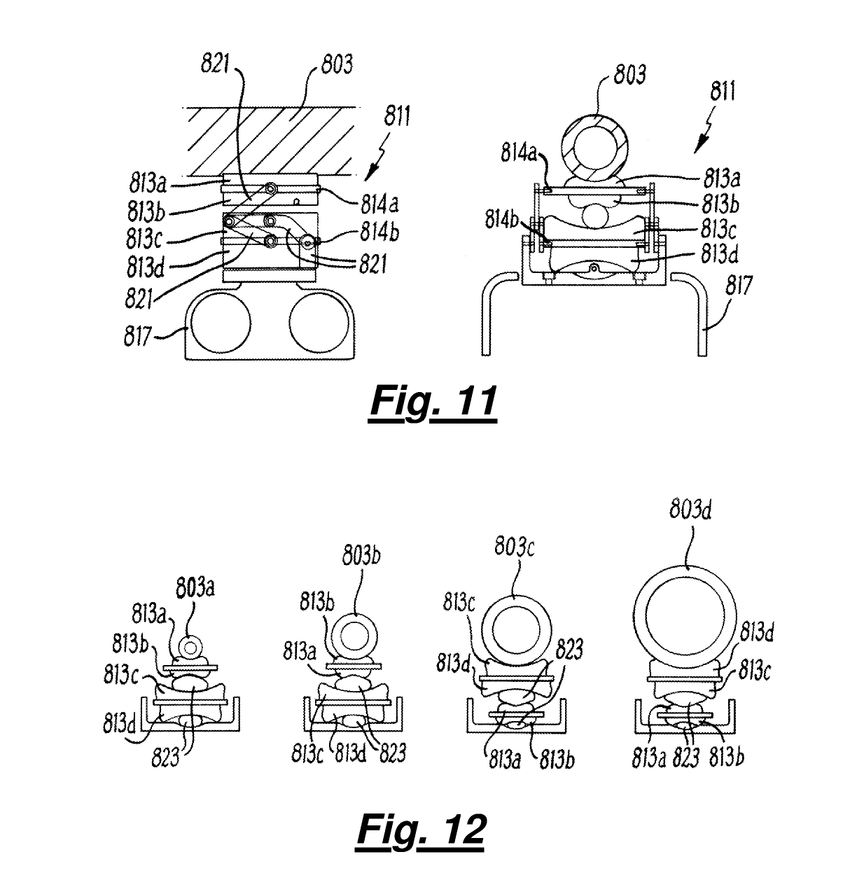

Another embodiment of the present invention is illustrated in FIG. 11. An improved tensioner pad assembly 811 is shown which comprises four separate tensioner pads 813a,813b,813c,813d of different configurations to accommodate different products 803. In this particular embodiment, pads 813a and 813b are mounted on opposite faces of a first pad plate 814a, and pads 813c and 813d are mounted on opposite faces of a second pad plate 814b.

Each pad plate 814a and 814b is mounted such that it can be flipped to present a different tensioner pad 813a or 813b, 813c or 813d (respectively) towards the product 803. Furthermore, the pad plates 814a,814b are so mounted that they may change places, the result being that the improved tensioner pad assembly 811 can be configured and repeatedly reconfigured so as to provide the effect of having four separate tensioner pads but without requiring the removal and replacement in order to accommodate different lay products.

In the illustrated embodiment, the plates 814a,814b are connected to the attachment 817 by way of a number of arms or linkages (indicated by reference number 821) which permit flipping and rotation of the plates 814a,814b while retaining the plates 814a,814b within a compact arrangement. However, it will be recognised that a number of alternative arrangements may be employed to realise the flipping and/or reversal of the tensioner pads 813a,813b,813c,813d—for example the plates 814a,814b could be connected or attached to one another and/or to the attachment 817 by clips which are unclipped and reclipped once the plates 814a,814b have been flipped and/or swapped round.

FIG. 12 illustrates, again in schematic form, the different tensioner pad configurations that can be realised using the improved tensioner pad assembly 811 illustrated in FIG. 11, which allows the single device of the invention to accommodate four different lay products 803a, 803b, 803c and 803d. In this embodiment, four different sizes of a similar product can be accommodated by providing different sized pads; it is also envisaged that pads of same or similar size but comprising different materials and/or different shapes (e.g. v-shapes) could be employed to accommodate same size but different material products. FIG. 14 illustrates how the plates and pads may be flipped and/or swapped using the above-mentioned arms or linkages.

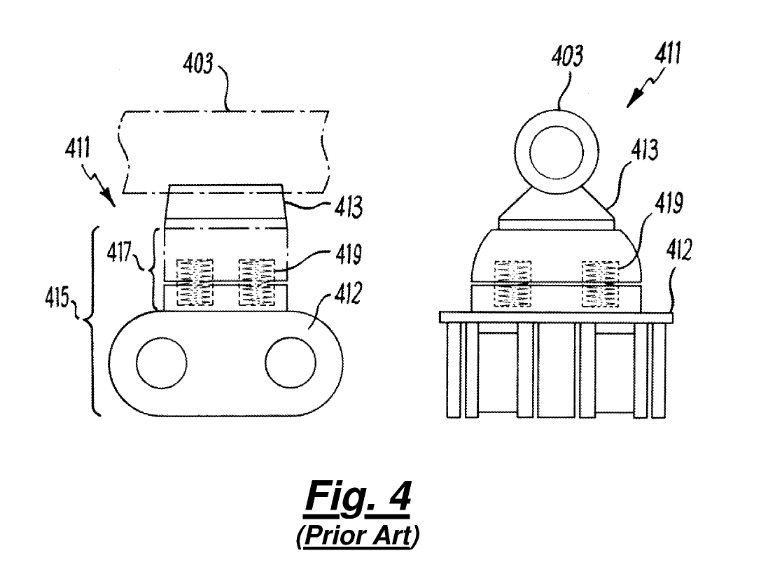

As illustrated in FIG. 4 and described in the background to the invention, it is beneficial to employ springs (e.g. 419) in tensioner pad assemblies to provide resilience and flexibility to accommodate changes in product diameter as it is laid. In the embodiment of the invention illustrated in FIGS. 11 and 12, the same functionality may be provided by employing optional supports or spacers 823 disposed between the plates 814a and 814b and between the lowermost plate 814a or 814b and the attachment 817. These spacers 823 not only help to locate and hold the plates 814a and 814b (and of course the attached tensioner pads 813a,813b,813c,813d) relative to one another and/or provide structural support to the improved tensioner pad assembly 811, but if the spacers 823 are comprised of a flexible, resilient and/or compressible material they may act in a similar manner as the springs and allow radial (with respect to a cross-section of the product) displacement of the pad 813a,813b,813c,813d presented to the product 803a,803b,803c,803d (respectively).

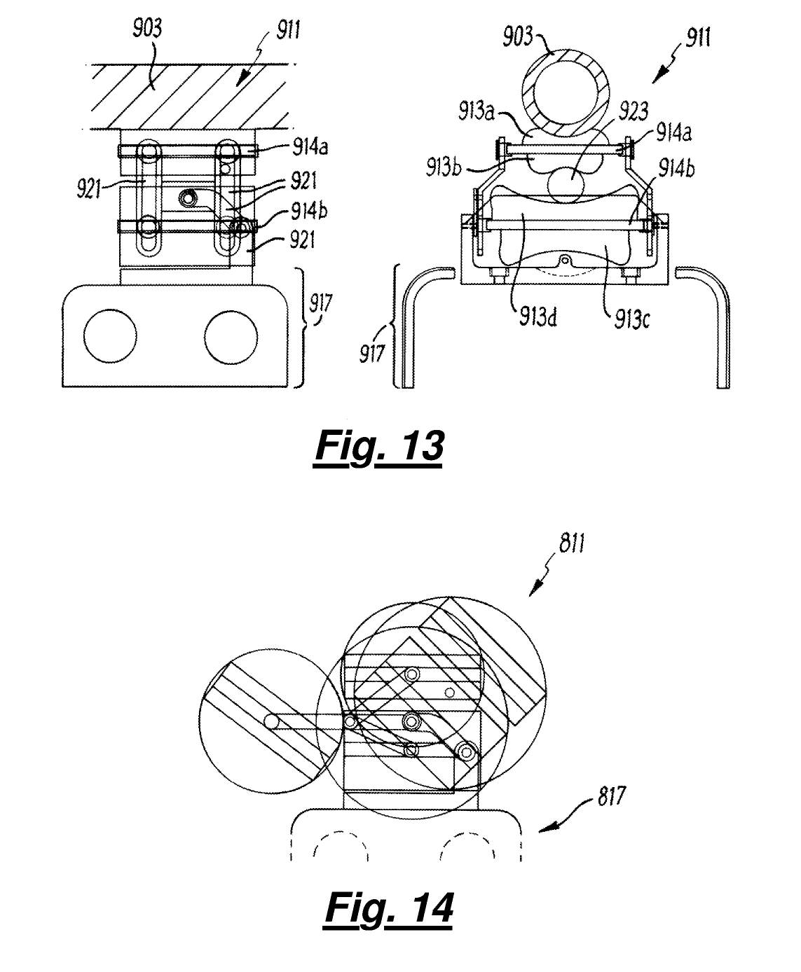

As shown in FIG. 13, an improved tensioner pad assembly 911 according to the invention can be provided with such functionality without the need for two spacers, and this can be achieved with one spacer 923 disposed between the plates 914a,914b. In fact, this spacer 923 can be solid, and the resilience, flexibility and/or compressibility required to allow radial displacement of the outermost pad (913a in this embodiment) provided by the combined or aggregated resilience, flexibility and/or compressibility of the four tensioner pads 913a,913b,913c,913d. Of course, it will be realised that this can be achieved even without the provision of one or more spacers.

FIG. 13 also illustrates (most evident in the side view) an alternative to the arrangement of arms or linkages (indicated by reference number 921) to that presented in FIG. 11, which also allows for the flipping and/or swapping of pad plates 914a,914b.

While the invention has been demonstrated by way of examples showing four different tensioner pads, it will be recognised that the benefits of the invention can be realised with any number of tensioner pads greater than one (for example, two as illustrated in the following embodiment). However, it is envisaged that an embodiment comprising a single tensioner pad may still benefit from the inventive concept by allowing the corresponding plate to be flipped to protect the tensioner pad and outwardly present a blank face of the plate. This configuration might be employed during transport, and the plate(s) flipped when the corresponding tensioner is to be used.

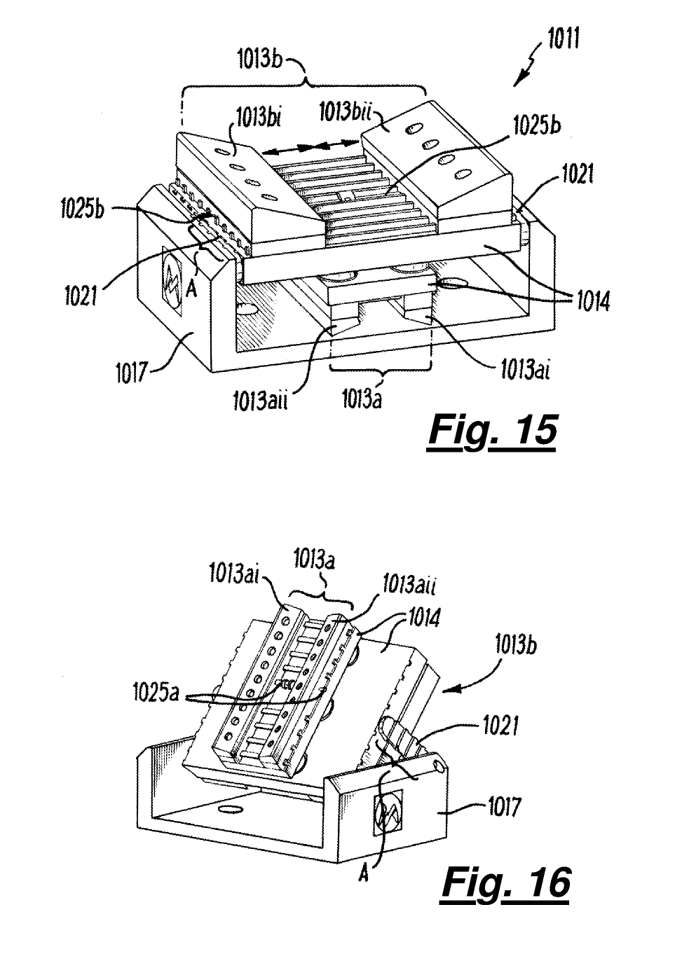

A further alternative embodiment of the invention is presented in FIG. 15, which illustrates an improved tensioner pad assembly 1011 comprising two tensioner pads 1013a,1013b mounted on opposite faces of a single pad plate 1014. The pad plate 1014 is flippable to present either tensioner pad 1013a,1013b towards the lay product (not shown in FIG. 15), by way of arms 1021 which are pivotally mounted to the pad plate 1014 at one end and pivotally mounted to the attachment 1017 (which is in turn attached to the track chain—not shown—of a pipe tensioner) to allow reversal of the pad plate 1014 as illustrated in FIG. 16 (which shows an intermediate stage in the flipping/reversal process).

Similarly to the tensioner pad 513 described above in relation to FIG. 5, the tensioner pads 1013a,1013b can be seen to comprise distinct and separate pad portions 1013ai,1013aii and 1013bi,1013bii (respectively). The pad portions 1013ai,1013aii,1013bi,1013bii are moveable laterally across the faces of the pad plate 1014 so as to adjust the separation there between. The separation is adjusted and/or controlled by way of threaded rods 1025a,1025b mounted on or in the pad plate 1014 and extending through both of the pad portions 1013ai,1013aii and 1013bi,1013bii (respectively).
Rotation of the threaded rods 1025a and 1025b in a first direction causes the pad portions 1013ai,1013aii and 1013bi,1013bii to move apart and rotation of the threaded rods 1025a and 1025b in a second direction (opposite sense to the first) causes the pad portions 1013ai,1013aii and 1013bi,1013bii to move towards one another. Of course the threaded rods 1025a,1025b can be operated independently of one another, although they could be linked. Corresponding channels or grooves on contacting surfaces of the pad plate 1014 and the pad portions 1013ai,1013aii and 1013bi,1013bii align and/or guide the pad portions 1013ai,1013aii and 1013bi,1013bii during movement to prevent twisting.

In a similar manner, the contacting faces of the pad plate 1014, arm 1021 and attachment 1017 (see region marked “A”) have corresponding channels or grooves to aid in alignment and to prevent twisting and/or displacement of the arms either during flipping (such as shown in FIG. 16) or when fixed in position in a first configuration (with tensioner pad 1013a presented to the product) or a second configuration (with tensioner pad 1013b presented to the product—such as shown in FIG. 15).

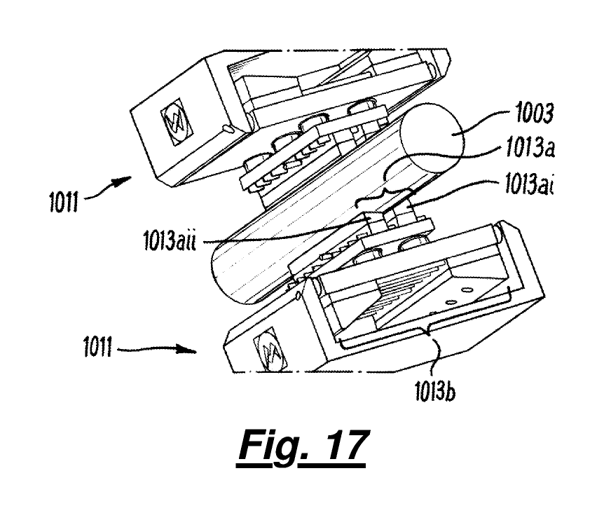

In a similar arrangement to that illustrated in FIG. 6, FIG. 11 illustrates two such improved tensioner pad assemblies 1011 disposed on either side of a product 1003. Comparing the configuration of the tensioner pad portions 1013ai and 1013aii in FIG. 17 to the configuration of the tensioner pad portions 1013ai and 1013aii in FIGS. 15 and 16, it can be seen that they have been brought closer together in order to accommodate a product 1003 of relatively small diameter.

The improved tensioner pad assemblies 1011 shown in FIG. 17 can also be flipped so as to present the similarly configured, but having larger tensioner pad portions 1013bi and 1013bii, tensioner pads 1013b. Such improved tensioner pad assemblies 1011 can therefore accommodate a first range of product diameters with first tensioner pads 1013a and a second range of product diameters with second tensioner pads 1013b.

Accordingly, with a single improved tensioner pad assembly in accordance with such an embodiment of the invention, pipe diameters between (say) 100 mm and 630 mm can be accommodated—again without the need to change pads. In conventional arrangements, at least three or four sets of pads would be required to achieve the same operational range—without the flexibility to ensure intermediate product sizes are provided with the same support as can be provided by the moveable pad portions 1013ai,1013aii and 1013bi,1013bii.

As noted above, the skilled person will readily appreciate that any manner or means of adjusting and/or controlling the separation of the pad portions may be employed, and that the provision of a threaded rod as illustrated on FIGS. 15 to 17 is simply one realisation. The pad portions may instead be positioned using one or more hydraulic cylinders (aka pistons) or the like, using linear positioners such as micrometers, or other equivalent means.

It will of course also be clear from the present disclosure that the benefits of the adjustable and/or controllable pad portion separation can be realised separately from the benefits of the flipping pad plate; accordingly, it will be understood that the invention finds utility in tensioner pad assemblies consisting of a single tensioner pad—although for the purposes of illustrating the invention it is helpful to describe the additional and combined benefits of having adjustable and/or controllable pad portion separation and being able to accommodate two or more different such tensioner pads in a single tensioner pad assembly. Furthermore, it will be realised that any number of such adjustable and/or controllable tensioner pads can be employed in a single improved tensioner pad assembly according to the present invention; for example four such tensioner pads could be employed in an improved tensioner pad otherwise substantially as described with reference to FIGS. 11 to 14.

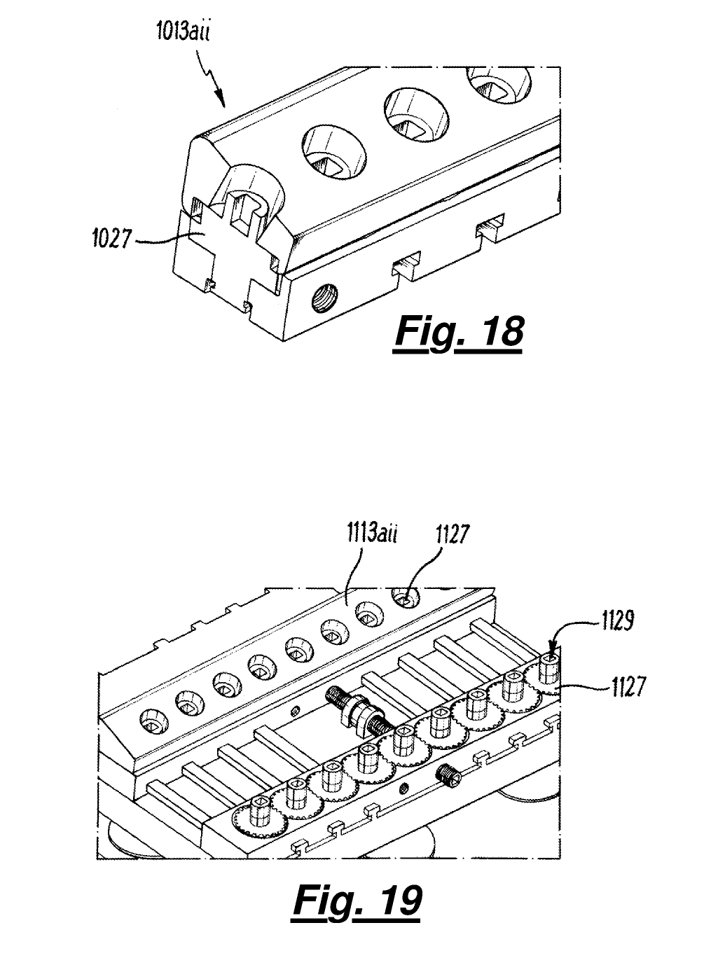

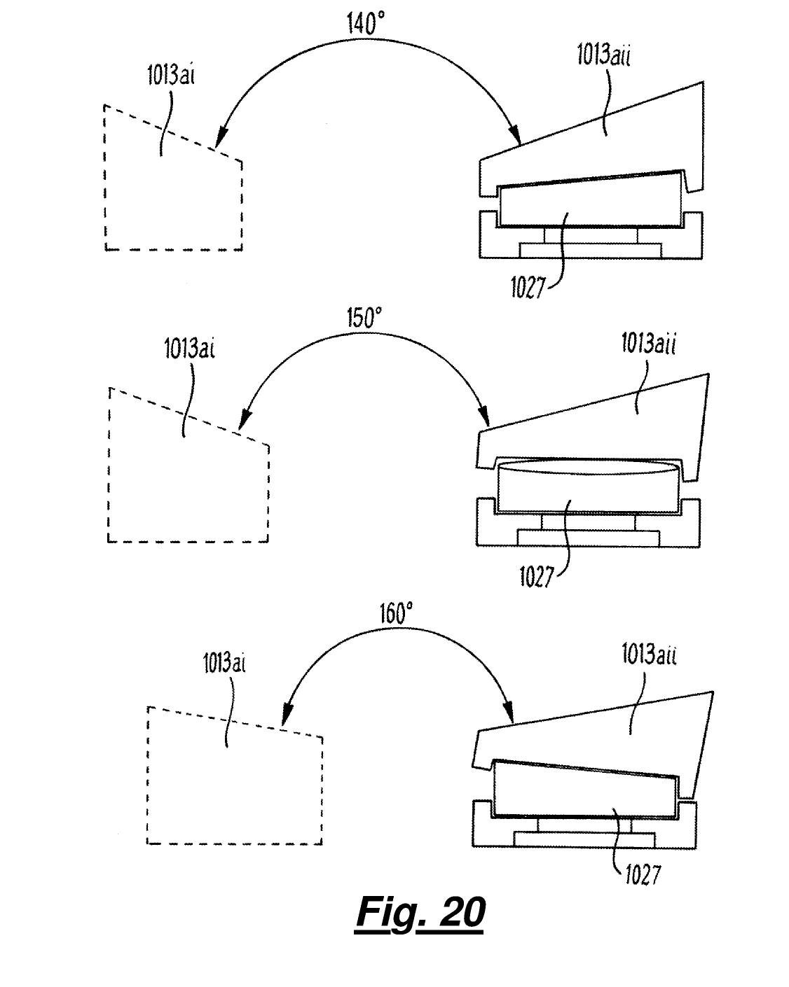

FIGS. 18 and 19 show further detail of pad portion 1013aii which has been adapted to provide additional adjustment to the angle of the by way of multiple inclined circular discs 1027. Rotation of these discs, which in this particular embodiment are interconnected, allow adjustment of the angle between opposing pad portions 1013aii and 1013ai between (for example) 140 degrees and 160 degrees (as shown in FIG. 20). In this embodiment, the discs comprise a keyed hole 1029 into which a corresponding key can be inserted to effect the required rotation. If interconnected, only one of the discs needs to be rotated. Of course, other means of effecting rotation can be employed, for example the use of a longitudinal worm drive—in which case the discs in opposing pad portions can be driven at the same time and by the same amount. Appropriate selection of pad shape and disc size and slope angle may provide different and/or lesser or greater operational ranges.

Note that in FIGS. 18 and 20 the discs 1027 are shown as having sloping upper faces whereas in FIG. 19 the discs 1127 have flat upper faces but sloping lower faces (not visible) which will be understood to provide the same effect.

Accordingly, when combined with the previously described embodiments, the invention may provide a single improved tensioner pad that is not only capable of handling pipe diameters ranging from (for example) 100 mm to 630 mm, but able to provide v-angles ranging between (for example) 140 degrees and 160 degrees—again without having to change tensioner pads. Currently, one would expect that such operational flexibility could only be obtained with at least 7 different sets of tensioner pads—and these would in any case still not be capable of adjustment to accommodate intermediate pipe diameters and/or different desired v-angles.

There are several benefits that the claimed invention in its varied embodiments (examples of which are described above) provide in relation to the prior art. For example, once a track-type pipe tensioner has been retro-fitted with the inventive tensioner pad assemblies it may be that the tensioner pads need never be changed again, other than to remedy wear and tear, yet the pipe tensioner will still be able to accommodate the full range of pipe product diameters and materials for a particular job or series of jobs. There is also a significant space saving because multiple sets of tensioner pads do not need to be stored on the vessel, other than any spares that are deemed appropriate to carry. Furthermore, it is expected that a full set of tensioner pad assemblies, according to the invention, can be reconfigured (by flipping, adjusting pad portion separation and/or pad portion angle) in around 3 hours which is significantly less vessel down-time and also allows the changeover to be performed during a single operating shift by a single team which has benefits in consistency as well. Knock-on benefits follow in scheduling, because the changeover times are so much shorter.

There are also safety benefits as there are no loose parts and manual handling of heavy parts is not necessary, and a corresponding reduced risk of dropping components and the damage and/or injury that such accidents can involve.

In particular embodiments, pad rubbers which are not in contact with the product being laid provide additional compliance to the tensioner pad overall which not only compensates for the lack of spring blocks used by the prior art (although spring blocks can be employed without departing from the scope of invention) but in actual fact may be more effective than spring blocks.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1.-17. (canceled)

18. A tensioner pad assembly for a track type tensioner, the tensioner pad assembly comprising a tensioner pad comprising a first pad portion, a second pad portion, and a separating means arranged to control a separation between the first pad portion and the second pad portion.

19. The tensioner pad assembly of claim 18, wherein the separating means permits continuous adjustment of the separation between the first and second pad portions.

20. The tensioner pad assembly of claim 19, wherein the separating means comprises one or more threaded rods.

21. The tensioner pad assembly of claim 19, wherein the separating means comprises at least one threaded rod extending between the first pad portion and second pad portion.

22. The tensioner pad assembly of claim 18, wherein the separating means permits discrete adjustment of the separation between the first and second pad portions.

23. The tensioner pad assembly of claim 18, wherein the separating means comprises a number of apertures in positions corresponding to different separations between the first pad portion and the second pad portion, the apertures adapted to receive at least one retaining member which holds the first pad portion and the second pad portion at the corresponding separation.

24. The tensioner pad assembly of claim 18, wherein the separation means comprises a number of slots in the first and second pad portions which define a corresponding number of separations, and at least one retaining member adapted to be received in one or more of the slots to hold the first pad portion and the second pad portion at the corresponding separation.

25. The tensioner pad assembly of claim 18, wherein the separating means comprises one or more hydraulic cylinders.

26. The tensioner pad assembly of claim 18, wherein the separating means comprises one or more linear positioners.

27. The tensioner pad assembly of claim 18, wherein the first and second pad portions and/or a plate supporting the first and second pad portions comprise corresponding channels or grooves to align and/or guide the first and second pad portions when moved by the separating means.

28. The tensioner pad assembly of claim 18, wherein the pad portions are provided with inclination adjustment means to control the inclination of a contact surface of the pad portions.

29. The tensioner pad assembly of claim 28, wherein the inclination adjustment means comprises one or more rotatable discs having at least one sloping face contacting a surface of the pad portion.

30. The tensioner pad assembly of claim 28, wherein the inclination adjustment means comprises one or more rotatable discs having at least one sloping face contacting a plate or pad carrier.

31. The tensioner pad assembly of claim 29 , wherein a plurality of rotatable discs are interconnected so as to transfer rotation from one disc to the next.

32. The tensioner pad assembly of claim 31, wherein the rotatable discs are rotated using a removable key or via a worm drive.

33. The tensioner pad assembly of claim 28, wherein the inclination adjustment means is configured to adjust between a pad angle of 140 degrees and a pad angle of 160 degrees.

34. A pipe tensioner comprising a plurality of tracks, each of the tracks comprising a plurality of tensioner pad assemblies according to claim 18.

35. A method of reconfiguring a pipe tensioner comprising a plurality of tracks, each of the tracks comprising a plurality of tensioner pad assemblies, each of the plurality of tensioner pad assemblies comprising a tensioner pad comprising a first pad portion, a second pad portion, and a separating means arranged to control a separation between the first pad portion and the second pad portion, comprising adjusting the separation between the first pad portion and the second pad portion of the tensioner pad assembly in order to accommodate a particular lay product.

36. A method of laying a pipe comprising driving or braking the tracks of a pipe tensioner according to claim 35 to control the speed at which the pipe is deployed.

37. A method of retrofitting an existing track type pipe tensioner, comprising replacing existing tensioner pads with tensioner pad assemblies according to claim 18.

38. The method of claim 37, further comprising removing the existing tensioner pads prior to fitting the tensioner pad assemblies.

39. (canceled)

40. A tensioner pad assembly for a track type tensioner, the tensioner pad assembly comprising a plurality of tensioner pads and configured to present a first of the tensioner pads to a product when in first configuration and present a second of the tensioner pads to the product when in a second configuration, and one or more of the tensioner pads comprising a tensioner pad assembly according to claim 1.
